(19) United States
(12) Patent Application Publication
(10) Pub. No.: US 2009/0187531 A1
(43) Pub. Date: Jul. 23, 2009

(54) USER EXPERIENCE FOR VIEWING BUSINESS DATA VIA PERSONAL INFORMATION APPLICATION

(75) Inventors: Sangya Singh, Bellevue, WA (US); Todd Abel, Redmond, WA (US); Kevin Reynolds, Bellevue, WA (US); Omer Rauf Atay, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/017,323

(22) Filed: Jan. 21, 2008

(51) Int. Cl. G06F 17/30; G06F 3/048

(52) U.S. Cl. 707/1; 715/764; 707/E17.009

(57) ABSTRACT

Architecture that provides a user experience (UX) for accessing business information (e.g., sales, accounts, opportunities) via an office application. In a specific implementation, a personal information manager (PIM) application includes a familiar UX that introduces a business context (e.g., sales) to tasks in the PIM application. Forms included as part of the PIM application (whether a contact form, appointment form, or a new form) comprise a new page (e.g., sales-related) that allows the user to view and navigate to business data related information that pertains to a task. For example, when accessing a business contact, the user can also navigate to and/or view opportunities associated with the contact.

### BACKGROUND

The utilization of applications familiar to a large number of users is a cost-effective and efficient way of improving productivity in the corporate environment. For example, the implementation of multiple different types of word processing applications can be counter-productive in the sharing of documents and data. For example, a significant improvement in efficiency and productivity could be achieved by using the day-to-day applications the employees are familiar with for interacting with the wide variety of data that can be found in corporate systems.

Sales professionals can make heavy use of office applications for accounts-related information such as for capturing business contacts in the company with which business is being conducted, meetings, and communications associated with opportunities being pursued with those accounts. Office applications can also be used for collaborating with teams on creating artifacts such as sales proposals, account plans and sales pitches, for example. By keeping with a familiar interface the learning curve should be significantly reduced such that the average sales representative, for example, can achieve usability within a very short period of time. A challenge is to provide key business constructs to end users in a familiar user experience for performing day-to-day tasks with business data and line-of-business applications.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The architecture provides access to business information (e.g., sales, accounts, opportunities) via an office application. In a specific implementation, a personal information manager (PIM) application includes a familiar user experience that introduces a business context (e.g., sales) to tasks in the PIM application. Forms included as part of the PIM application (whether a contact form, appointment form, or a new form) comprise a new page or group (e.g., sales-related) that allows the user to view and navigate to business data related information that pertains to a PIM item (e.g., a task). For example, when accessing a business contact, the user can also navigate to and/or view opportunities associated with the contact.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented system for interacting with business data.

FIG. 2 illustrates the implementation of business data access via personal information forms.

FIG. 3 illustrates an exemplary PIM application form that combines sales information with personal information in a familiar user experience.

FIG. 4 illustrates an exemplary PIM application account form that shows business opportunities combined with personal information in a familiar user experience.

FIG. 5 illustrates an exemplary PIM application account form that shows business contact information combined with personal information in a familiar user experience.

FIG. 6 illustrates an exemplary PIM application opportunity form that shows business opportunity information combined with personal information in a familiar user experience.

FIG. 7 illustrates an additional exemplary PIM application sales activity form that shows business sales activity information combined with personal information in a familiar user experience.

FIG. 8 illustrates an exemplary PIM application contact form that shows business contact information combined with personal information in a familiar user experience.

FIG. 9 illustrates a computer-implemented method of presenting business data in association with a PIM application.

FIG. 10 illustrates an alternative method of presenting business data.

FIG. 11 illustrates a block diagram of a computing system operable to execute business data in association with personal information items in accordance with the disclosed architecture.

### DETAILED DESCRIPTION

The disclosed architecture introduces business constructs into applications that users generally interact with in day-to-day work such as office applications. In one particular implementation, the business constructs are employed in a personal information manager (PIM) application (e.g., Outlook™ by Microsoft Corporation) that provides functionality related to personal notes, journals, tasks, email, calendar, reminders, voicemail, for example.

The architecture provides a user experience (UX) for navigating to business related information on a given PIM item (e.g., a task), viewing the business information, and pivoting (summarizing data) the business information. Although the description focuses on a UX for navigating, viewing and pivoting sales/accounts data on PIM items, the UX architecture extends to other types of business context such as human resources, recruiting, travel management, CRM (customer relationship management), financials, and so on.

The UX can be provided in both online and offline modes and in a seamless way. The UX allows users to create, view, and update account data and make the data available to the platform components for synchronization with backend systems. The user has explicit control over when the data is being published to the backend systems. The user is now is able to perform a large portion of the tasks involving account via the UX architecture and can fall back to the backend system for the remainder of the work, if needed.

The UX architecture via the PIM application that introduces new forms and data for descriptions related to opportunities, accounts, leads, etc., and extends existing PIM items (e.g., appointment, email, task, etc.) by linking the items to business data (e.g., sales).

The UX architecture introduces line-of-business (LOB) data in the context of the user's tasks, for example, in a consistent familiar experience. For example, when viewing a business contact the user can access and view the opportunities in which the contact is participating, when reviewing a sales visit appointment the user can access and view what the appointment is about and the related account, and when reviewing an opportunity the user can access and view all the business contacts working on this opportunity and which activities have taken place (e.g., site visits, calls made to the customer, proposals presented, etc.).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

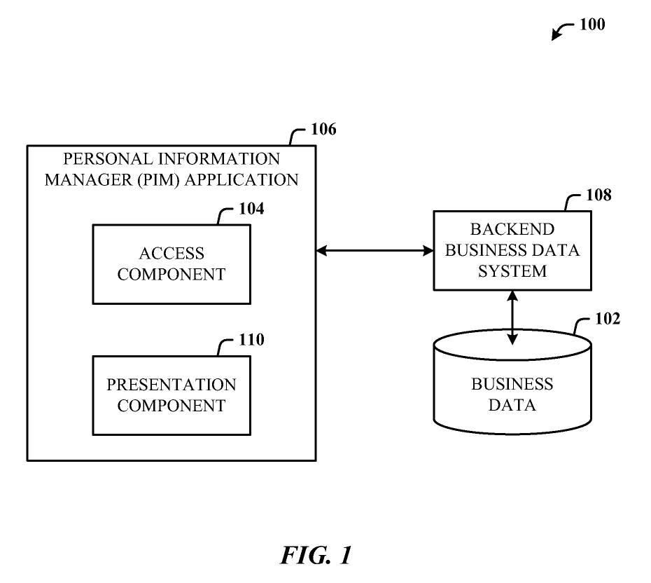

FIG. 1 illustrates a computer-implemented system 100 for interacting with business data 102. The system 100 includes an access component 104 of a PIM application 106 for accessing the business data 102 of a backend business data system 108. A presentation component 110 of the PIM application 106 for navigating to and interacting with the business data 102. The access component 104 can be code that installs separately or is designed into the PIM application 106 to facilitate access to the backend business data system 108 and the associated business data 102.

The presentation component 110 can include a user interface that facilitates the UX by providing navigation tools or objects via which a user can interact to access the business data 102. The tools or objects can be integrated into forms, templates or other documents of the PIM application 106 to provide the familiar experience that the user may already have learned during day-to-day use of the PIM 106 or similar application type. The tools or objects can be provided as selectable icons in menus or tabs, for example, of the user interface.

The user can select and interact with an item (e.g., a task, a contact, etc.) normally utilized in the PIM application 106 in response to which the access component 104 can access business data 102 associated with the item for presentation. For example, selection of a task item can result in account, contact, opportunity, and/or sales activity information being retrieved and displayed in forms of the PIM application 106 for viewing by the user. The forms provide the same general look and feel (UX) normally associated with a PIM application, but further include the business data and navigational tools for pivoting and/or accessing further business data and/or personal information.

It is to be appreciated that the business data can be presented in association with any personal information application and via any device. For example, the business data and related form options can be presented to a user via a mobile device (e.g., cell phone, PDA), a desktop computer, portable computer, etc.

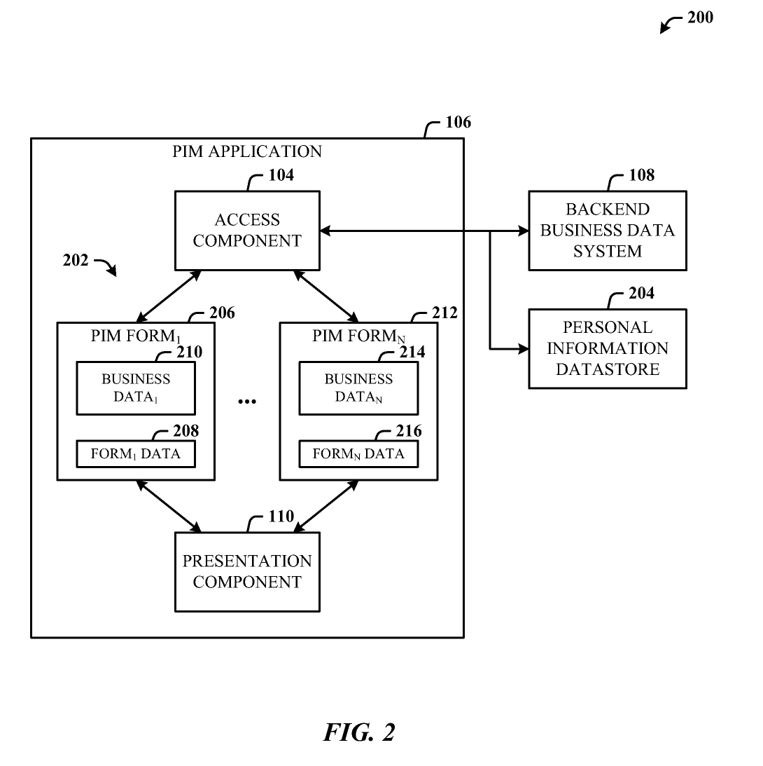

FIG. 2 illustrates the implementation of business data access via personal information forms. Here, the PIM application 106 includes multiple PIM forms 202 (denoted PIM Form_{1-N}) that include form data (denoted Form Data_{1-N}) found in typical PIM applications, for example, menus, calendar, contacts, reminders, contact information, email, etc., which provide the familiarity aspect in the user experience of the users. In support of now accessing and presenting business data in the PIM forms 202, the forms 202 now include business data (denoted Business Data_{1-N}) retrieved from the backend business data system 108. The PIM forms 202 include personal information items (e.g., contacts, tasks, emails, calendar events, reminders, etc., as the form data) associated with specific and/or general categories of business data items. Thus, the PIM application 106 includes one or more items via which business data related to the one or more items is exposed. The forms 202 will also present the PIM form data associated with the given form. In other words, different PIM forms 202 can include different sets of form data, as well as different sets of business data. The user can navigate to the different forms 202 using menus, links, icons, or other means typically associated with accessing different forms, document or pages of information.

The access component 104 facilitates accessing and retrieving at least the business data and the personal information from the corresponding data sources, for example, the backend business data system 108 and a personal information datastore system 204 that stores or provides for the retrieval of information related to contacts, email, contact information, etc. The presentation component 110 then presents the forms, business data, and personal information for a given form for user interaction. The presentation component 110 also presents user-selectable navigation tools for accessing and pivoting the business data via a PIM form.

In one example, a user launches the PIM 106, which then presents a first PIM form 206 that includes a first set of personal information form data 208 and a first set of business data 210. The user can interact with the first set of form data 208 and/or the first set of business data 210 to navigate to a second form 212 to view a different set of business data 214 and a different set of form data 216. The PIA 106 includes a personal information form that presents business-related account information, contacts information, and/or sales activity information based on selection of a personal information item. Moreover, the business data can be associated with one or more of company sales, human resources, travel management, finance, or recruiting, as example of some of the business data for which access and presentation in the familiar user experience can be obtained. In other words, the presentation component 110 of the PIM 106 provides a familiar user experience by merging business-related options into personal information forms and presenting the business data in association with items of the personal information.

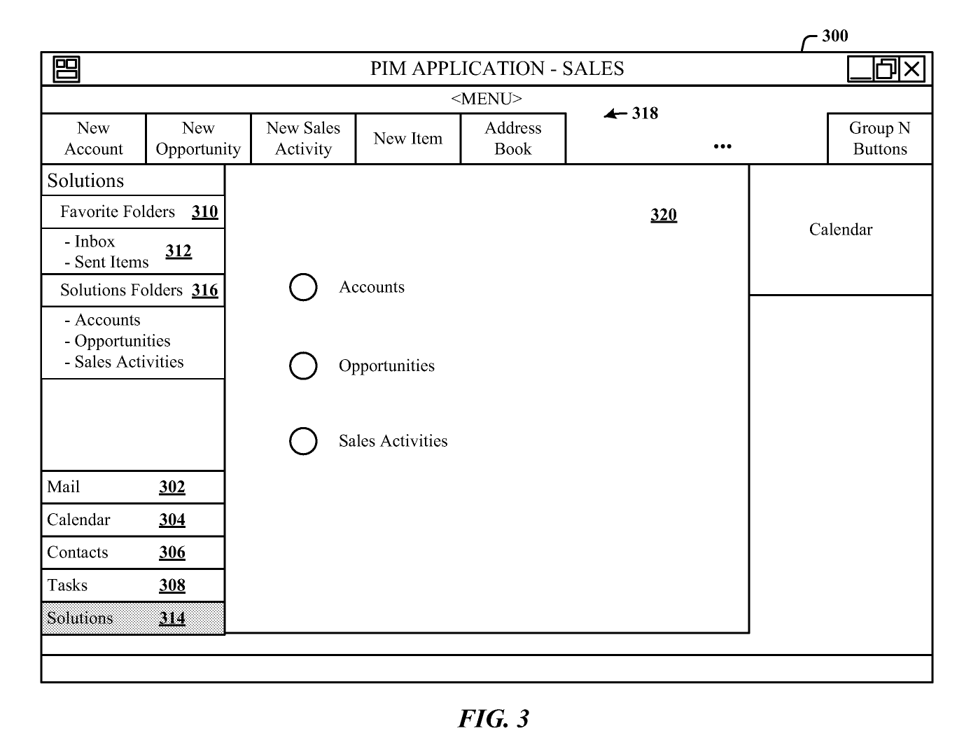

Following are a series of user interface forms for accessing and presenting business data via forms that can also present personal information. Note that although shown in the context of sales data, the business data could also be related to human resources information, financial information, recruiting, travel management, etc., and it not to be construed as limiting in any way. FIG. 3 illustrates an exemplary PIM application form 300 that combines sales information with personal information in a familiar user experience. The personal information accessible and presented can include Mail 302, Calendar 304, Contacts 306, Tasks 308, Favorite Folders 310 and, Inbox and Sent Items (for email) 312, for example. The business data access can be provided via a Solutions item 314 which is associated with Solutions folders 316 such as Accounts, Opportunities, and Sale Activities. The Solutions item 314 can be automatically included in the personal information form 300 when the business application functionality is installed on the client machine, thereby providing access to the modified forms that include both business data and personal information. The sales business data is synchronized with the business data system (e.g., CRM) on the client and surfaced as a folder in the PIM application form 300. This allows the user to use the native PIM application experience to browse, search and filter on sales data. Business contacts from the business data system synchronize with the contacts folder 306 of the PIM application, for example.

The PIM application form 300 can also include menu items 318 related to the navigation of not only personal information but also business data. Here, an exemplary set of menu items 318 includes, but is not limited to, business data access associated with a New Account, a New Opportunity, New Sales Activity, and personal information related to an Address Book. A main navigation pane 320 can also be provided with more detailed description information about Accounts, Opportunities, and Sales Activities and with options to select to this business data.

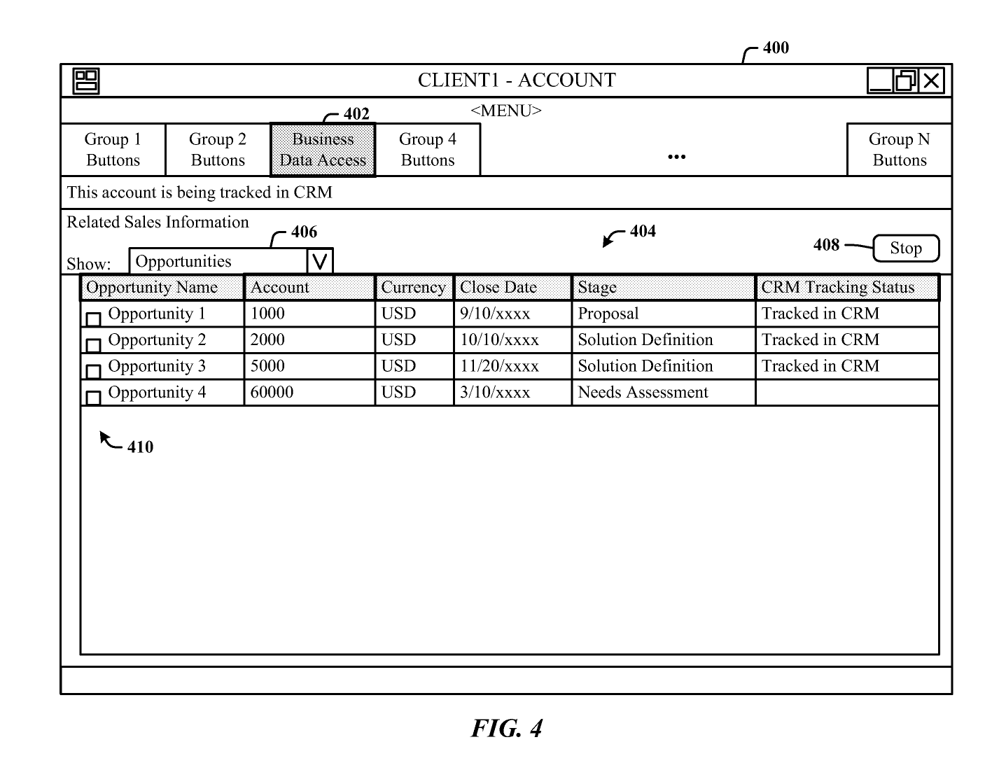

FIG. 4 illustrates an exemplary PIM application account form 400 that shows business opportunities combined with personal information in a familiar user experience. A new page (generally referred herein to as a business data access menu selection 402) is added to personal information application forms. This new page or group 402 can be carried through to other form menus in the same or similar way to allow the user to select the business data associated with item of the personal information application (e.g., PIM application). Other button groups can be provided for personal information navigation (e.g., address book, contacts, email, etc.). On the page/group, the user is provided options to choose the type of sales data for viewing. The forms can show related business data types related to opportunities, contacts, and sales activities. Here, the user has selected an opportunities list 404 for viewing using a dropdown menu 406. The dropdown menu 406 allows the user to select sales data, for example, to view around this personal information item (account). The user can chose to present all business data types in one view.

On the forms there can be lists that show actual instances of the business (e.g., sales) data the user wants to view. The columns on the list 404 can differ based on the type of sales data to show. For example, if viewing related opportunities for the account, the user can also choose to view opportunity name, amount, close date, stage, tracking status, etc. Here, the list 404 shows sales data of the type (e.g., opportunity) selected by the user in the dropdown menu 406. When viewing related activities for the account, the user can choose to view the type of activity, subject, priority, status, for example.

On the form 400, the user can also select a button 408 to stop refreshing the list 404 when the list 404 is querying large sets of data. In other words, the button 408 can be enabled for use when the list 404 is getting populated. For example, if on an account there are 1000 activities, the user can decide to stop refreshing the data currently being presented. In this case only the activities that got added to the list in the allowed amount of time will be shown.

The list 404 also can include context-sensitive actions accessible by the user (e.g., a right-click menu). In other words, a right-click menu on an Opportunity name (e.g., Opportunity 1) will be different than the menu for the sales activity. Double-clicking a list item opens the item in a new form. Thus, as the user views related Opportunities on an account form, the user can double-click a particular row to open the particular Opportunity in a separate window. Associated with each row item in the list 404 is an icon 410 the selection of which triggers presentation of a visual representation of the list item being shown.

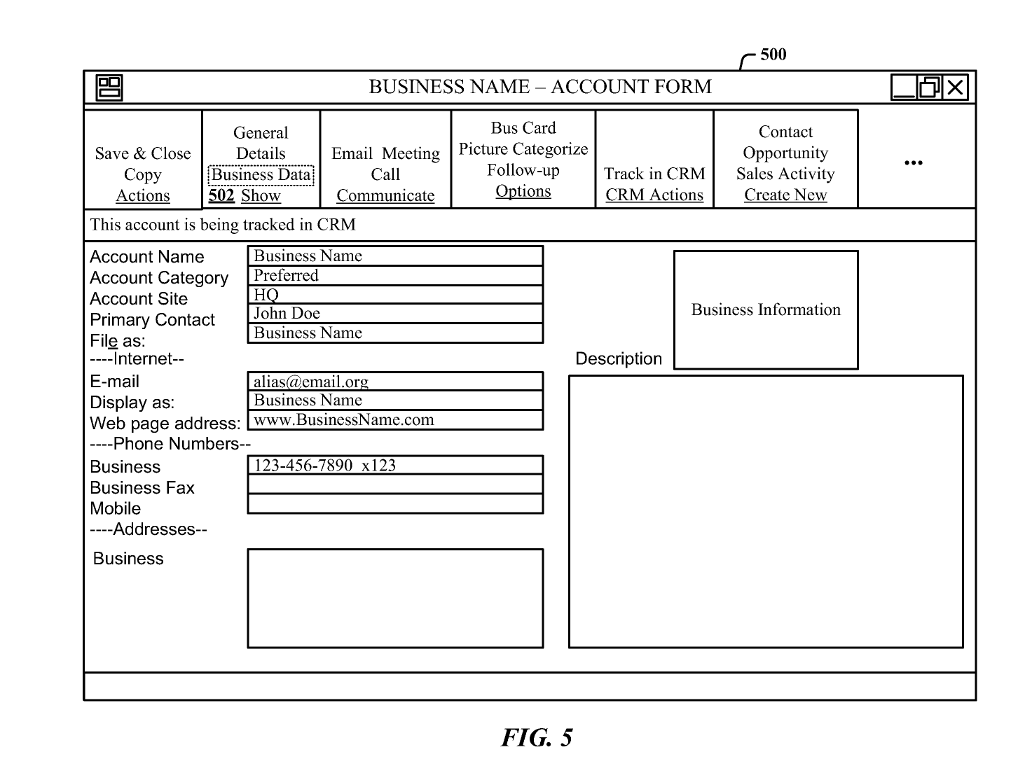

FIG. 5 illustrates an exemplary PIM application account form 500 that shows business contact information combined with personal information in a familiar user experience. The contact information can include business account contact information (e.g., account name, account category, account contact, etc.), Internet access information (e.g., business email, website address, etc.), business phone and fax data, business address and so on. The account form 500 includes a business data access page/group 502 denoted here as Show, which includes a Business Data selection (emphasized for this description inside a dotted-line box) for accessing business data related to this account.

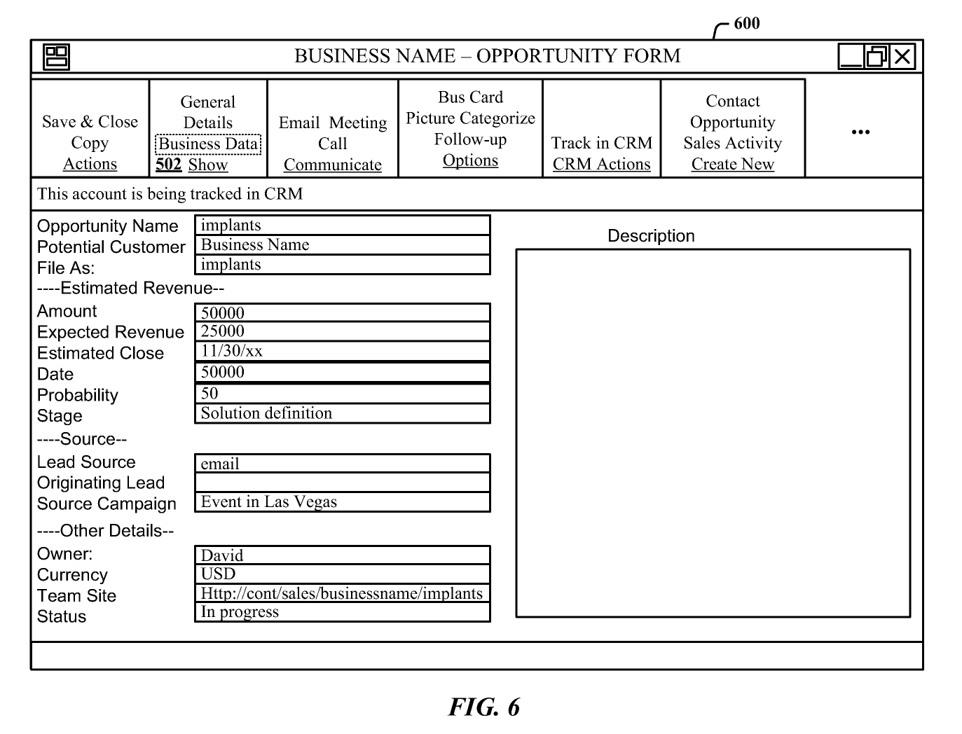

FIG. 6 illustrates an exemplary PIM application opportunity form 600 that shows business opportunity information combined with personal information in a familiar user experience. The opportunity information can include name, potential customer, revenue information source of the opportunity, business owner, etc. The opportunity form 600 includes the business data access page/group 502 denoted here as Show, which includes a Business Data selection for accessing business data related to this opportunity. Menu items allow for accessing other business data and personal information, for example.

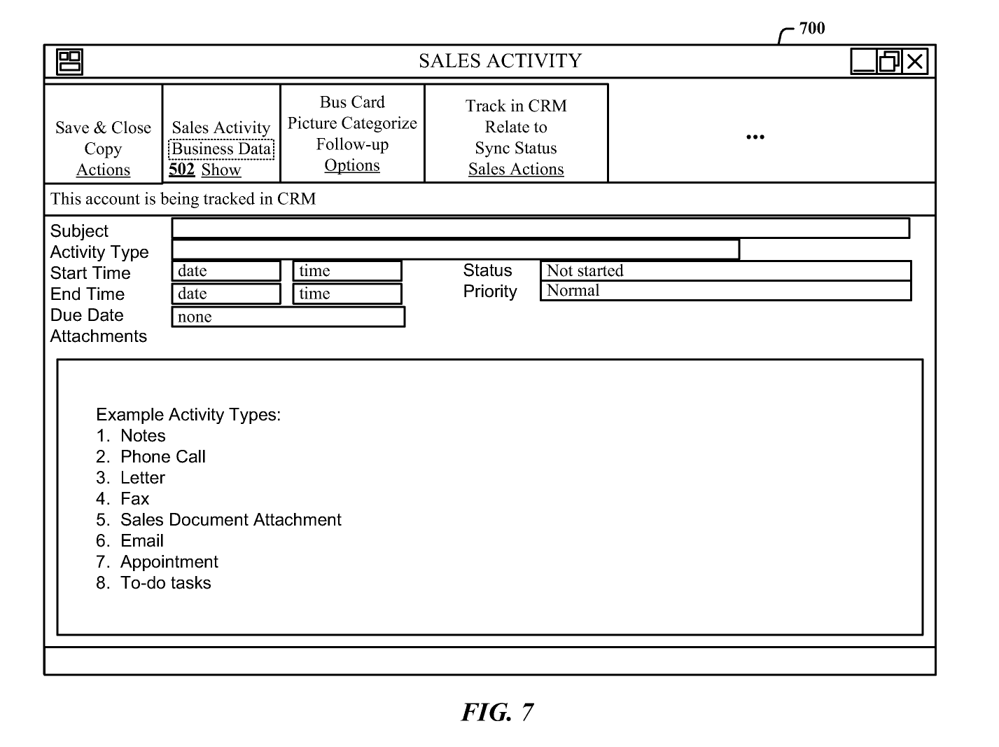

FIG. 7 illustrates an additional exemplary PIM application sales activity form 700 that shows business sales activity information combined with personal information in a familiar user experience. The sales activity form 700 includes the business data access page/group 502 denoted here as Show, which includes a Business Data selection for accessing business data related to this sales activity. Example activity types include notes, phone call, letter, fax, sales document attachment, email, appointment, and to-do tasks, for example.

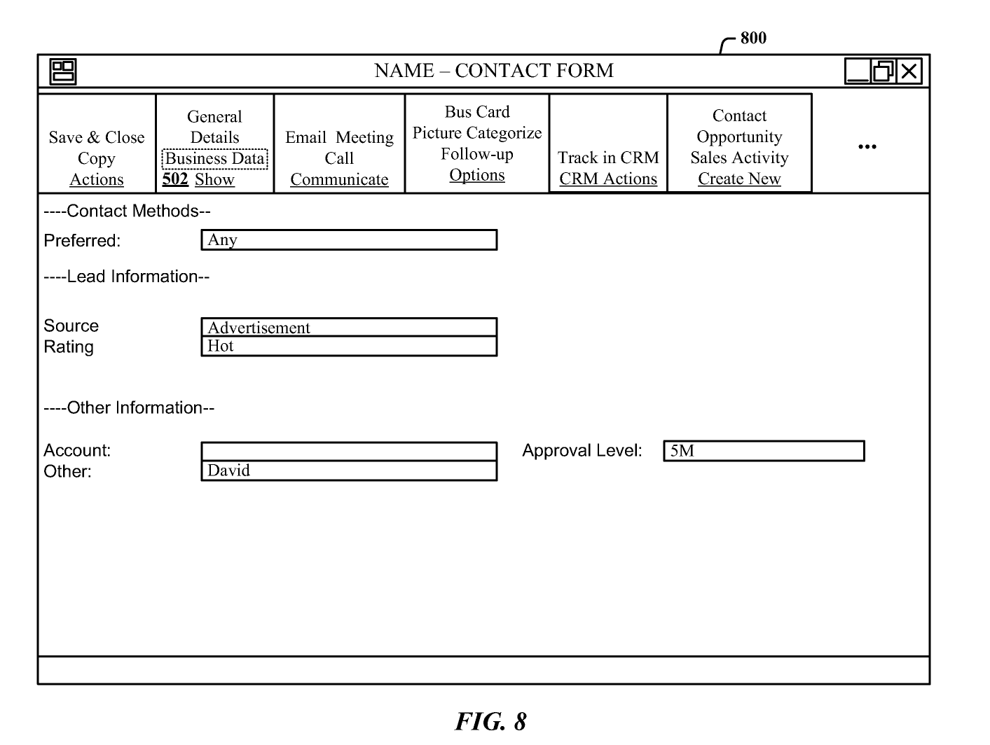

FIG. 8 illustrates an exemplary PIM application contact form 800 that shows business contact information combined with personal information in a familiar user experience. The contact form 800 includes the business data access page/group 502 denoted here as Show, which includes a Business Data selection for accessing business data related to this contact. The feature set can include offline business contacts in a main contact folder, the capture of sales details, the captures of leads as contacts, new sales activity, and a global view of the contacts.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

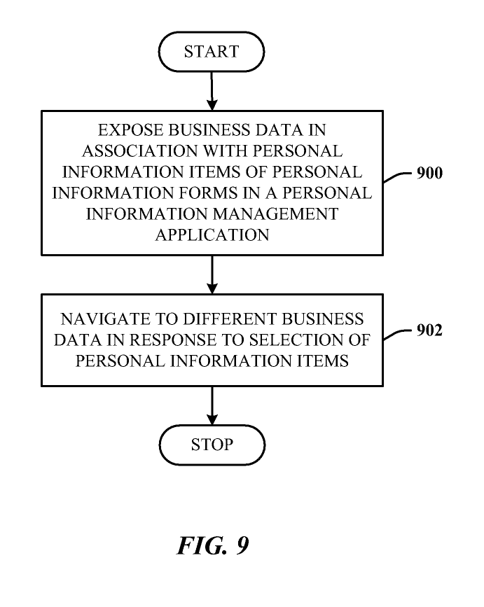

FIG. 9 illustrates a computer-implemented method of presenting business data. At 900, business data objects are installed in personal information forms of a PIM application. At 902, the business data of the objects is exposed in association with personal information items of the forms. At 904, the system navigates to different business data in response to selection of the personal information items.

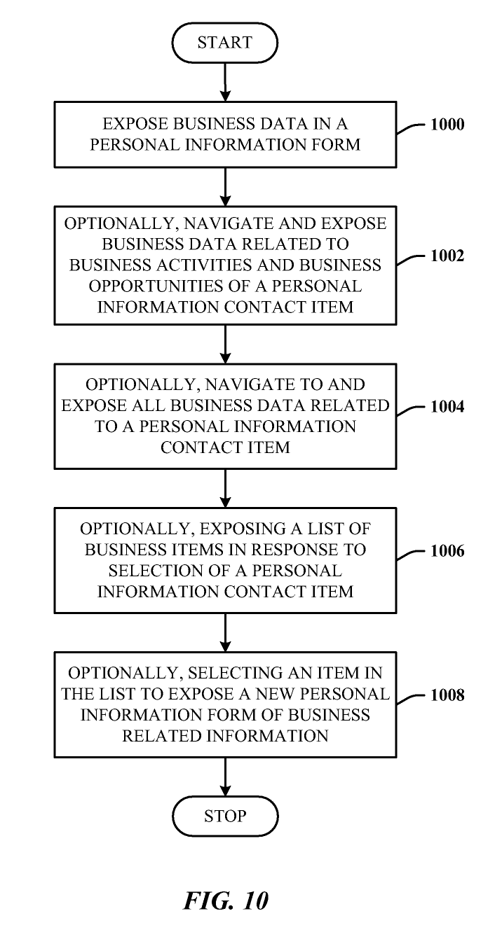

FIG. 10 illustrates an alternative method of presenting business data. At 1000, business data is exposed in a personal information form. At 1002, optionally, the system provides navigation tools for navigating to and exposing business data related to business activities and business opportunities of a personal information contact item. At 1004, optionally, the system provides navigation tools for navigating to and exposing all business data related to business activities and business opportunities of a personal information contact item. At 1006, expose list of business items in response to selection of a personal information contact item. At 1008, optionally, select an item of the list to expose a new personal information form of business related information.

While certain ways of displaying information to users are shown and described with respect to certain figures as screenshots, those skilled in the relevant art will recognize that various other alternatives can be employed.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

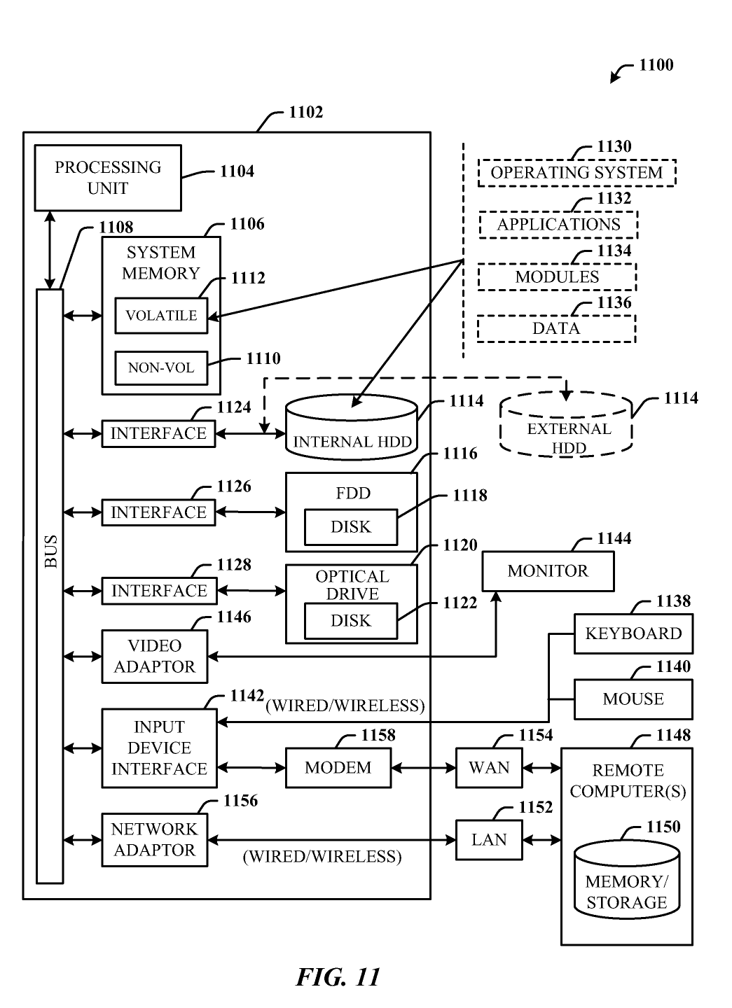

Referring now to FIG. 11, there is illustrated a block diagram of a computing system 1100 operable to execute business data in association with personal information items in accordance with the disclosed architecture. In order to provide additional context for various aspects thereof, FIG. 11 and the following discussion are intended to provide a brief, general description of a suitable computing system 1100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102 having a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 can include non-volatile memory (NON-VOL) 1110 and/or volatile memory 1112 (e.g., random access memory (RAM)). A basic input/output system (BIOS) can be stored in the non-volatile memory 1110 (e.g., ROM, EPROM, EEPROM, etc.), which BIOS are the basic routines that help to transfer information between elements within the computer 1102, such as during start-up. The volatile memory 1112 can also include a high-speed RAM such as static RAM for caching data.

The computer 1102 further includes an internal hard disk drive (HDD) 1114 (e.g., EIDE, SATA), which internal HDD 1114 may also be configured for external use in a suitable chassis, a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as a DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1112, including an operating system 1130, one or more application programs 1132, other program modules 1134, and program data 1136. The one or more application programs 1132, other program modules 1134, and program data 1136 can include PIM 106, the access component 104, the presentation component 110, the PIM forms (202, 206 and 212), the business data (210 and 214), the form data (208 and 216), and the PIM forms (400, 500, 600, 700 and 800), for example. Where the computing system 1100 is employed as a server, the server system can include the backend business data system 108, the business data 102, and/or the personal information datastore 204, for example.

All or portions of the operating system, applications, modules, and/or data can also be cached in the volatile memory 1112. It is to be appreciated that the disclosed architecture can be implemented with various commercially available operating systems or combinations of operating systems.

A user can enter commands and information into the computer 1102 through one or more wire/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, etc.

A monitor 1144 or other type of display device is also connected to the system bus 1108 via an interface, such as a video adaptor 1146. In addition to the monitor 1144, a computer typically includes other peripheral output devices (not shown), such as speakers, printers, etc.

The computer 1102 may operate in a networked environment using logical connections via wire and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, is connected to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for interacting with business data, comprising:
an access component of a personal information manager (PIM) application for accessing business data; and
a presentation component of the PIM application for navigating to and interacting with the business data.

2. The system of claim 1, wherein the PIM application includes one or more items via which business data related to the one or more items is exposed.

3. The system of claim 1, wherein the PIM application includes one or more personal information forms that are populated with related portions of the accessed business data.

4. The system of claim 1, wherein the presentation component presents user-selectable navigation tools for accessing and pivoting the business data via a PIM form.

5. The system of claim 1, wherein the PIM application includes a PIM form that presents business-related contact information based on selection of a personal information item.

6. The system of claim 1, wherein the PIM application includes a PIM form that presents business-related account information based on selection of a personal information item.

7. The system of claim 1, wherein the PIM application includes a PIM form that presents business-related sales activity information based on selection of a personal information item.

8. The system of claim 1, wherein the business data is associated with one or more of company sales, human resources, customer relation management, travel management, finance, or recruiting.

9. A computer-implemented system for interacting with business data, comprising:
an access component of a PIM application for accessing business data and personal information; and
a presentation component of the PIM application for providing a familiar user experience by merging business-related options into PIM forms and presenting the business data in association with items of the personal information.

10. The system of claim 9, wherein the business-related options include an option to stop refresh of a list of business data in a PIM form.

11. The system of claim 10, wherein the presentation component presents context-sensitive options for an item of the list.

12. The system of claim 10, wherein the presentation component presents the item in a new form in response to selection of the item in the list.

13. The system of claim 10, wherein the presentation component presents new columns of information in the list based in part on a type of the business data.

14. A computer-implemented method of presenting business data, comprising:
exposing business data in association with personal information items of PIM forms of a PIM application; and
navigating to different business data in response to selection of the personal information items.

15. The method of claim 14, further comprising pivoting the business data in response to selection of different business data types.

16. The method of claim 14, further comprising controlling refresh of a list of the business data.

17. The method of claim 14, further comprising exposing business data in a PIM form related to business opportunities and business activities.

18. The method of claim 14, further comprising exposing business data in a PIM form related to business contacts.

19. The method of claim 14, further comprising exposing all business data related to a business contact.

20. The method of claim 14, further comprising presenting graphical indicia in association with a business data item which when selected presents a visual representation of the item.
